(19) United States
(12) Patent Application Publication
(10) Pub. No.: US 2021/0176955 A1
(43) Pub. Date: Jun. 17, 2021

(54) Hay Net

(71) Applicant: Leslie W. Davis, Spicewood, TX (US)

(72) Inventor: Leslie W. Davis, Spicewood, TX (US)

(21) Appl. No.: 17/187,767

(22) Filed: Feb. 27, 2021

Related U.S. Application Data
(63) Continuation-in-part of application No. 15/873,392, filed on Jan. 17, 2018, now abandoned.
Application No. 15/873,392 is a continuation-in-part of application No. 14/929,585, filed on Nov. 2, 2015, now abandoned.
Application No. 14/929,585 is a continuation-in-part of application No. 12/932,763, filed on Mar. 7, 2011, now abandoned.

(51) Int. Cl. A01K 5/00

(52) U.S. Cl. CPC A01K 5/008

(57) ABSTRACT

The hay net is a durable net configured to fit over a hay bale, where the holes within the net are sufficiently large enough to allow livestock to eat the hay through the holes yet small enough to restrict the rate at which the hay is eaten, so as to reduce the rate livestock eat, which improves digestion. Also included is the method of use.

### AMENDED CROSS-REFERENCE TO RELATED APPLICATIONS

| | | |
|---|---|---|
| 12/932,763 | Mar. 7, 2011 | Davis |
| 14/929,585 | Feb. 25, 2016 | Davis |
| 15/873,392 | Nov. 2, 2015 | Davis |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

The hay net is a net with specifically sized holes designed to cover a hay bale that has been placed out for livestock to feed upon. The intent of the hay net is to cause livestock to draw the hay of the hay bale through the holes in the net before the food can be eaten, so as to cause livestock to eat more slowly in order to improve digestion and decrease the likelihood of certain diseases. To accomplish the desired goal, the net is made of material durable enough to withstand the bite from the livestock yet soft enough so as not to irritate the nose of the livestock during eating, which would otherwise discourage eating, said material to be selected from materials commonly used in the industry including but not limited to nylon, polypropylene, polyethylene, or cotton, wherein the diameter of the material ranges from 2.0 mm to 15 mm. The holes within the net are so dimensioned as to be large enough to allow the animal to feed through yet small enough to reduce the rate at which the animal eats, for example, 1.75 inches and 2.0 inches on a side which have been identified as causing the desired effect for horses.

### Background of the Invention

This application is a continuation in part of U.S. patent application Ser. No. 12/932,763 filed Mar. 7, 2011, a continuation in part of U.S. patent application Ser. No. 14/929,585 filed Nov. 2, 2015, and a continuation in part of U.S. patent application Ser. No. 15/873,392 filed Jan. 17, 2018. The benefit of the earlier filing dates of the aforementioned U.S. patent application Ser. Nos. 12/932,763, 14/929,585, and 15/873,392 is hereby claimed.

The hay net was created in response to research that demonstrated that when horses eat more slowly, they are less susceptible to diseases such as laminitis. Specifically, if horses were forced to eat through 2″ holes, they would eat more slowly, which then limits the warming effects of rapid ingestion of proteins that would otherwise provide a favorable environment for toxins to develop in the hooves of the horse. The challenge is to develop a method of slowing ingestion by livestock that was inexpensive, but which would made from material that would be sufficiently durable to resist exposure to the elements and the impact of frequent biting (given that a horse bite delivers pressure in excess of 2,000 pounds per inch), while the material would be sufficiently soft and pliable so as to not discourage the livestock from eating. The hay bale netting with which hay bale rolls are bound when they are harvested have been used to support the tight binding of hay to keep its rolled (wrapping the circumference) or rectangular shape (wrapping the length and height) for the purpose of transportation, this netting is usually a flat plastic or twisted twine 0.0254 mm up to 1.5 mm thick and this hay bale netting is not sufficiently durable for long term use as it breaks easily, and is applied during the baling process with the use of a baling machine. Moreover, it has been shown that thee hay bale netting is a danger to livestock in that this plastic material can be chewed through by livestock, ingested, and then collects in the livestock's colon or intestines, which places the life of the livestock in danger. See ED DIMMARD, “The Rap on Bale Wrap”, Web Article, Jan. 15, 2016, University of Florida IFAS Extension, http://nwdistrict.ifas.ufl.edu/phag/2016/01/15/the-rap-on-bale-wrap/; MARTHA MOBLEY, “The Simplest Things . . . Feeding Hay”, Web Article, Mar. 11, 2015, NC Coop. Ext., https://franklin.ces.nesu.edu/2015/01/the-simplest-things-feeding-hay/; UofFL “Horse Owner Alert: Dangers with Round Bale”, Web, Sep. 13, 2012, http://largeanimal.vethospitals.ufl.edu/2012/09/13/notice-to-horse-owners-dangers-with-round-bale-netting/; and NDSU, “Remove Net Wrap from Forages”, Web Article, Nov. 21, 2014, https://www.ag.ndsu.edu/livestockextension/remove-net-wrap-from-forages. Several attempts have been made to create a means to restrict the rate at which livestock eat, all of which can be distinguished from the present disclosure.

### AMENDED SUMMARY OF THE INVENTION

The hay net is a net designed to be placed loosely over a roll of hay to restrict livestock to eating through the holes in the net, where the holes act to restrict the rate at which livestock eat. The holes within the net are so dimensioned as to be large enough to allow the animal to feed through yet small enough to reduce the rate at which the animal eats. The material with which the hay net is made is sufficiently durable to resist exposure to the elements and the impact of frequent biting by the livestock, while the material would be sufficiently soft and pliable so as to not discourage the livestock from eating, said material to be selected from materials commonly used in the industry including but not limited to nylon, polypropylene, polyethylene, or cotton, wherein the material is twisted, the diameter of the material ranges from 2.0 mm to 15 mm, and because of the thickness the material cannot be fed into a baler.

The first embodiment of the hay net comprises a net of sufficient size to cover the hay bale, where the material with which the net is made is of sufficient durability to resist exposure to the elements and the impact of frequent biting by the livestock, where the holes within the net are so dimensioned as to be large enough to allow the animal to feed through yet small enough to reduce the rate at which the animal eats.

The second embodiment of the hay net comprises a net of sufficient size to cover the hay bale, where the material with which the net is made is of sufficient durability to resist exposure to the elements and the impact of frequent biting by the livestock, where the holes within the net are so dimensioned as to be large enough to allow the animal to feed through yet small enough to reduce the rate at which the animal eats, where in addition to the material for the net there are a plurality of additional ropes woven through the net in such a fashion that, once the net is loosely draped over the hay bale, these additional plurality of ropes are drawn tight so that the hay net restricts the hay from spreading across the ground, which prevents the hay from being trampled and wasted.

The third embodiment of the hay net comprises a net of sufficient size to cover the hay bale, where the material with which the net is made is of sufficient durability to resist exposure to the elements and the impact of frequent biting by the livestock so that the material cannot be swallowed, where the holes within the net are so dimensioned as to be large enough to allow the animal to feed through yet small enough to reduce the rate at which the animal eats, where in addition to the material for the net there are a plurality of contracting ropes woven through the net in such a fashion that, once the net is draped over the hay bale, these additional plurality of ropes contract so that the hay net assists in holding the form of the hay bale together, to restrict the hay from spreading across the ground, which prevents the hay from being trampled and wasted.

Each embodiment of the hay net may also comprise a plurality of centering ropes that are woven through the hay net from edge to edge and through the center, wherein these plurality of centering ropes aid in ensuring the entire hay bale is covered by the hay net.

### BRIEF DESCRIPTION OF THE SEVERAL VIEWS OF THE DRAWING

FIG. 1 is a view of the hay net loosely draped over a hay bale;

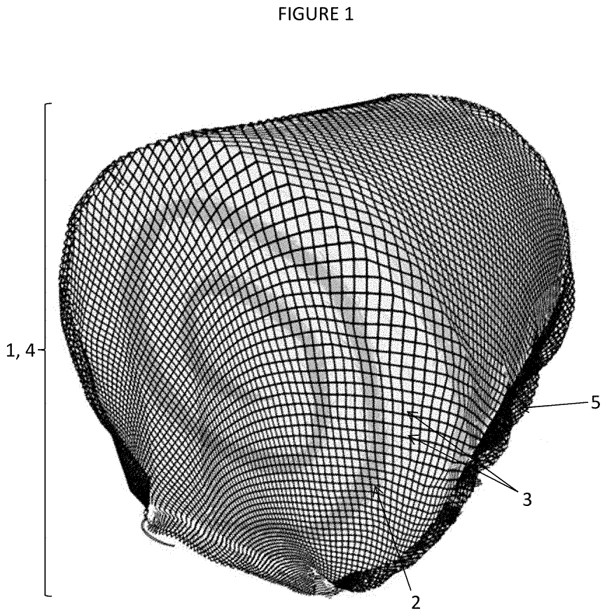

FIG. 2 is a view of the first embodiment of the hay net including the net, the material that makes up the net, and the holes in the net;

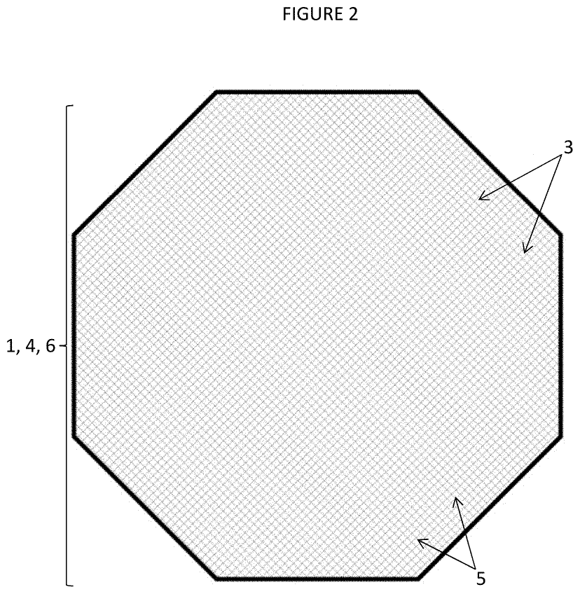

FIG. 3 is a view of the second embodiment of the hay net additionally including the plurality of additional ropes that are used to draw the hay net against the hay bale; and

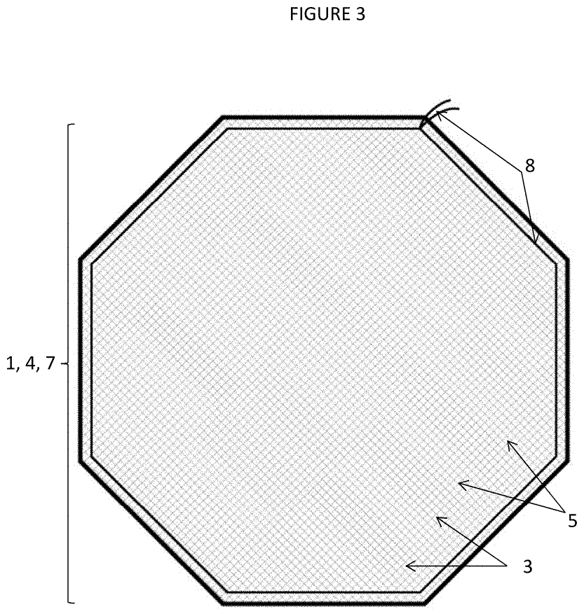

FIG. 4 is a view of the third embodiment of the hay net additionally including the plurality of contracting ropes that are used to contract the hay net against the hay bale; and

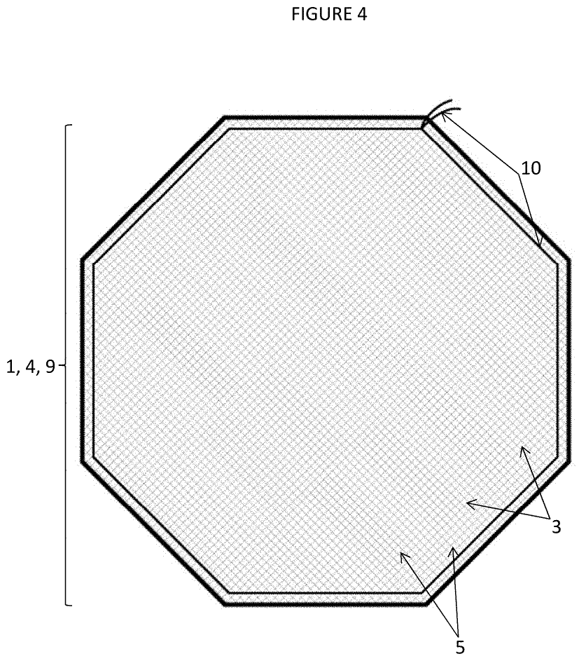

FIG. 5 is a view of the first embodiment of the hay net additionally including a plurality of centering ropes;

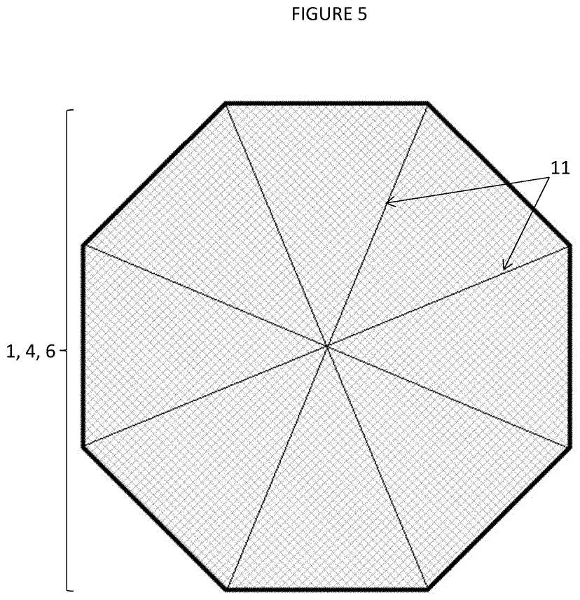

FIG. 6 is a view of the second embodiment of the hay net additionally including a plurality of centering ropes; and

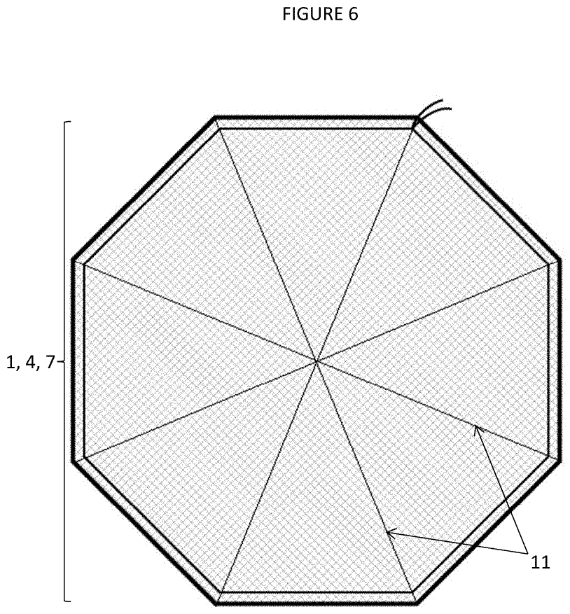

FIG. 7 is a view of the third embodiment of the hay net additionally including a plurality of centering ropes.

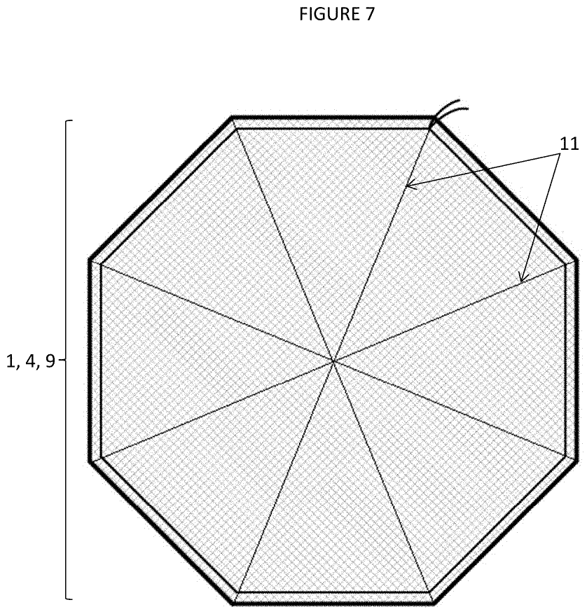

### AMENDED DETAILED DESCRIPTION OF THE INVENTION

The hay net 1 is a net designed to be loosely placed over a hay bale 2 to restrict livestock to eating through specifically sized holes 3 in the net 4, which slows down the rate at which the livestock eat and improves digestion. The material 5 with which the net 4 is made is sufficiently durable resist exposure to the elements and the impact of frequent biting by the livestock so that the material cannot be swallowed, while the material 5 is sufficiently soft and pliable so as to not discourage the livestock from eating, said material to be selected from materials commonly used in the industry including but not limited to nylon, polypropylene, polyethylene, or cotton, wherein the material is twisted together, possesses a diameter of 2.0 mm to 15 mm, and because of the thickness cannot be fed into a baler.

The first embodiment 6 of the hay net 1 comprises a net 4 of sufficient size to cover the hay bale, where the material 5 with which the net 4 is made is of sufficient durability to resist exposure to the elements and the impact of frequent biting by the livestock, where the holes 3 within the net 2 are so dimensioned as to be large enough to allow the animal to feed through them yet small enough to restrict the rate at which the animal eats.

The second embodiment 7 of the hay net 1 comprises a net 4 of sufficient size to cover the hay bale, where the material 5 with which the net 4 is made is of sufficient durability to resist exposure to the elements and the impact of frequent biting by the livestock, where the holes 3 within the net 4 are so dimensioned as to be large enough to allow the animal to feed through them yet small enough to reduce the rate at which the animal eats, where in addition to the material 5 for the net 4 there are a plurality of additional ropes 8 woven through the net 4 in such a fashion that, once the net 4 is loosely draped over the hay bale, these plurality of additional ropes 8 can be drawn tight so that the net assists in holding the hay bale together, to restrict the hay from spreading across the ground, which prevents the hay from being trampled and wasted.

The third embodiment 9 of the hay net 1 comprises a net 4 of sufficient size to cover the hay bale, where the material 5 with which the net 4 is made is of sufficient durability to resist exposure to the elements and the impact of frequent biting by the livestock, where the holes 3 within the net 4 are so dimensioned as to be large enough to allow the animal to feed through them yet small enough to reduce the rate at which the animal eats, where in addition to the material 5 for the net 4 there are a plurality of contracting ropes 10 woven through the net 4 made of an elastic material such that, once the net 4 is draped over the hay bale, these plurality of contracting ropes 10 hold the net 4 against the hay bale and contract as the hay bale is being consumed, so as to aid in holding the hay bale together during consumption.

In addition to the above mentioned embodiments for the hay net 1, the first embodiment 6, second embodiment 7, and third embodiment 9 may have a plurality of centering ropes 11 weaved through the net 4 from edge to edge and through the center, wherein these plurality of centering ropes 11 aid in ensuring the net 4 is centered over the hay bale 2 and the entire hay bale 2 is covered by the net 4.

The method of use of the hay net 1 is that the hay net 1 is draped over a bale or pile of hay. The plurality of additional ropes 8 may be drawn tight so that the net assists in holding the hay bale together, to restrict the hay from spreading across the ground. The contracting ropes 10 may be used to ensure the hay net 1 is contracted against the bale or pile of hay. The centering ropes 11 may be used to ensure the hay net 1 is properly centered over the bale or pile of hay.

What is claimed:

1. A hay net for the purpose of restricting the rate livestock eat in order to improve digestion comprising:
a net of sufficient size to entirely cover a hay bale;
wherein the hay net is loosely placed over a hay bale;
where the material with which the net is made is of sufficient durability to resist exposure to the elements and the impact of frequent biting by the livestock so that the material cannot be swallowed, while sufficiently soft and pliable so as to not discourage livestock from eating;
the material with which the net is made to be selected from at least one of nylon, polypropylene, polyethylene, and/or cotton;
with a diameter of 2.0 mm to 15 mm, which is too large to fit into a baler; and
where the holes within the net are so dimensioned as to be large enough to allow the animal to feed through them yet small enough to reduce the rate at which the animal eats.

2. The hay net of claim 1 where there are a plurality of centering ropes woven through the net from edge to edge and through the center, wherein these plurality of centering ropes aid in ensuring the net is centered over the hay bale and the entire hay bale is covered by the net.

3. The hay net of claim 1 where there are a plurality of additional ropes woven through the net in such a fashion that, once the net is draped over the hay bale, these plurality of additional ropes can be drawn tight so that the net assists in holding the hay bale together.

4. The hay net of claim 3 where there are a plurality of centering ropes woven through the net from edge to edge and through the center, wherein these plurality of centering ropes aid in ensuring the net is centered over the hay bale and the entire hay bale is covered by the net.

5. The hay net of claim 1 there are a plurality of contracting ropes woven through the net made of an elastic material such that, once the net is draped over the hay bale, these plurality of additional ropes hold the net against the hay bale and contract as the hay bale is being consumed, so as to aid in holding the hay bale together during consumption.

6. The hay net of claim 5 where there are a plurality of centering ropes woven through the net from edge to edge and through the center, wherein these plurality of centering ropes aid in ensuring the net is centered over the hay bale and the entire hay bale is covered by the net.

7. A method of use of the hay net as described in claims 1 through 6 wherein said method of use comprises:
draping the hay net over a bale or pile of hay.

8. A method of use of claim 7 wherein pulling additional ropes hold the pile or bale of hay together.

9. The method of use of claim 8 wherein pulling contracting ropes hold the hay net against the pile or bale of hay.

10. The method of use of claim 9 wherein pulling centering ropes center the hay net over the pile or bale of hay.

11. The method of use of claim 7 wherein pulling contracting ropes hold the hay net against the pile or bale of hay.

12. The method of use of claim 11 wherein pulling centering ropes center the hay net over the pile or bale of hay.

13. The method of use of claim 8 wherein pulling centering ropes center the hay net over the pile or bale of hay.

14. The method of use of claim 7 wherein pulling centering ropes center the hay net over the pile or bale of hay.
